(19) United States
(12) Patent Application Publication
(10) Pub. No.: US 2019/0102726 A1
(43) Pub. Date: Apr. 4, 2019

(54) CONTROL METHOD AND INFORMATION PROCESSING DEVICE

(71) Applicant: FUJITSU LIMITED, Kawasaki-shi (JP)

(72) Inventors: Kazumasa Ushiki, Kawasaki (JP); Akira Fujii, Machida (JP)

(73) Assignee: FUJITSU LIMITED, Kawasaki-shi (JP)

(21) Appl. No.: 16/133,906

(22) Filed: Sep. 18, 2018

(30) Foreign Application Priority Data
Sep. 29, 2017 (JP) 2017-189658

(51) Int. Cl. G06Q 10/06; G06Q 50/14; H04W 4/021; H04W 4/02; H04W 4/029

(52) U.S. Cl. CPC G06Q 10/063116; G06Q 50/14; H04W 4/029; H04W 4/027; H04W 4/022

(57) ABSTRACT

Provided is a program causing a computer to execute a process including: storing schedule information including an execution order of activities; obtaining geofence information including positional information indicating a departure place of each activity and time information indicating time to transmit an advance notice regarding expectation of arrival at a first departure place of a first activity next to a second activity to a device of a business operator providing the first activity, specifying a next activity based on the schedule information; generating, based on time information in the geofence information corresponding to the next activity and speed information indicating user's moving speed, distance information corresponding to the time information; and transmitting, to another device of another business operator providing the next activity, the advance notice regarding expectation of arrival at a next departure place of the next activity based on user's entering into a geofence and the distance information.

### CROSS-REFERENCE TO RELATED APPLICATION

This application is based upon and claims the benefit of priority of the prior Japanese Patent Application No. 2017-189658, filed on Sep. 29, 2017, the entire contents of which are incorporated herein by reference.

### FIELD

A certain aspect of embodiments described herein relates to a non-transitory computer readable storage medium, a control method, and an information processing device.

### BACKGROUND

There has been known technology called geofencing that gives notice of entry into a certain area to a user holding a terminal or transmits the entry into the certain area to an external device when it is detected that the moving terminal has entered the certain area of which the range is defined by a virtual fence (geofence) as disclosed in, for example, Japanese National Publication of International Patent Application No. 2011-524123 and Japanese Laid-open Patent Publication No. 2017-111001.

On the other hand, there has been known a style of a tour in which a plurality of activities such as trekking and kayaking are included in one tour. In many cases, the tour organizer estimates the time required for each activity and the time from the end of the previous activity to the start of the next activity, and organizes the tour schedule.

Before the tour starts, the tour organizer gives prior information on the user who is to experience the activity to the business operator providing each activity via mail, facsimile, or electronic mail. The prior information includes, for example, the scheduled arrival time of the user to the place where the activity starts and the number of users expected to arrive. Furthermore, in the case of an escorted tour, the tour conductor may provide the detailed state of traveling of the users on the day of the tour to each business operator via telephone. Each business operator starts preparation for accepting the users according to the scheduled arrival time and the number of persons expected to arrive based on the prior information on the users and the state of traveling from the tour conductor.

### SUMMARY

According to an aspect of the present invention, there is provided a non-transitory computer readable storage medium storing a control program causing a computer to execute a process, the process including: storing schedule information including an execution order of activities to be conducted by a user; obtaining geofence information including positional information and time information, the positional information indicating a departure place of each activity of the activities, the time information indicating time to transmit an advance notice regarding expectation of arrival at a first departure place of a first activity next to a second activity to a first device of a business operator providing the first activity, the first and second activities being from among the activities; specifying a next activity to be conducted by the user based on the schedule information; generating, based on time information in the geofence information corresponding to the next activity and speed information indicating a speed at which the user moves, distance information corresponding to the time information; and transmitting, to a device of a next business operator providing the next activity, the advance notice regarding expectation of arrival of the user at a next departure place of the next activity based on entering of the user into a geofence defined by the positional information of the geofence information corresponding to the next activity and the distance information.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram for describing an exemplary information processing system;

FIG. 2 illustrates an exemplary hardware configuration of a user terminal;

FIG. 3 illustrates an exemplary hardware configuration of a management server;

FIG. 4 illustrates an exemplary block diagram of the user terminal, the management server, and a business operator terminal in accordance with a first embodiment;

FIG. 5 illustrates an example of a schedule table;

FIG. 6 illustrates an example of a geofence table;

FIG. 7 illustrates an example of a user management table;

FIG. 8 illustrates another example of the user management table;

FIG. 9 is a flowchart of an exemplary process executed by a first processing unit;

FIG. 10 illustrates an example of a screen displayed on the user terminal;

FIG. 11 is a flowchart of an exemplary process executed by a controller;

FIG. 12 illustrates another example of the screen displayed on the user terminal;

FIG. 13 is a flowchart of an exemplary process executed by a geofence processing unit;

FIG. 14A through FIG. 14D are diagrams for describing the state of entering of the user into a geofence;

FIG. 15 is a flowchart of another exemplary process executed by the first processing unit;

FIG. 16 is a flowchart of an exemplary process executed by an updating unit;

FIG. 17 is an exemplary block diagram of the user terminal, the management server, and the business operator terminal in accordance with a second embodiment;

FIG. 18 illustrates another example of the schedule table;

FIG. 19 illustrates another example of the geofence table;

FIG. 20 illustrates an example of a staff management table;

FIG. 21 is a diagram for describing a start time of an activity and an organization providing the activity;

FIG. 22 is a graph for describing a relationship between the number of staff persons and work time;

FIG. 23 is a flowchart of another exemplary process executed by the geofence processing unit;

FIG. 24 is a flowchart of an exemplary process executed by the first processing unit and the second processing unit; and

FIG. 25A1 through FIG. 25B2 are other examples of the setting of a third geofence.

### DESCRIPTION OF EMBODIMENTS

In recent years, the style of a tour allowing a user to freely select a plurality of activities without a tour organizer is increasing. In such a style of a tour, since there may be a case where the above described tour conductor is not traveling with the user, the state of traveling of the user on the day of the tour may not be provided to each business operator. As a result, each business operator can know the activity selected by the user in advance as the prior information, but cannot know the state of traveling of the user on the day of the tour, and there is a risk that preparation for accepting the user is not smoothly conducted.

Hereinafter, a description will be given of embodiments for carrying out the present case with reference to the accompanying drawings.

### First Embodiment

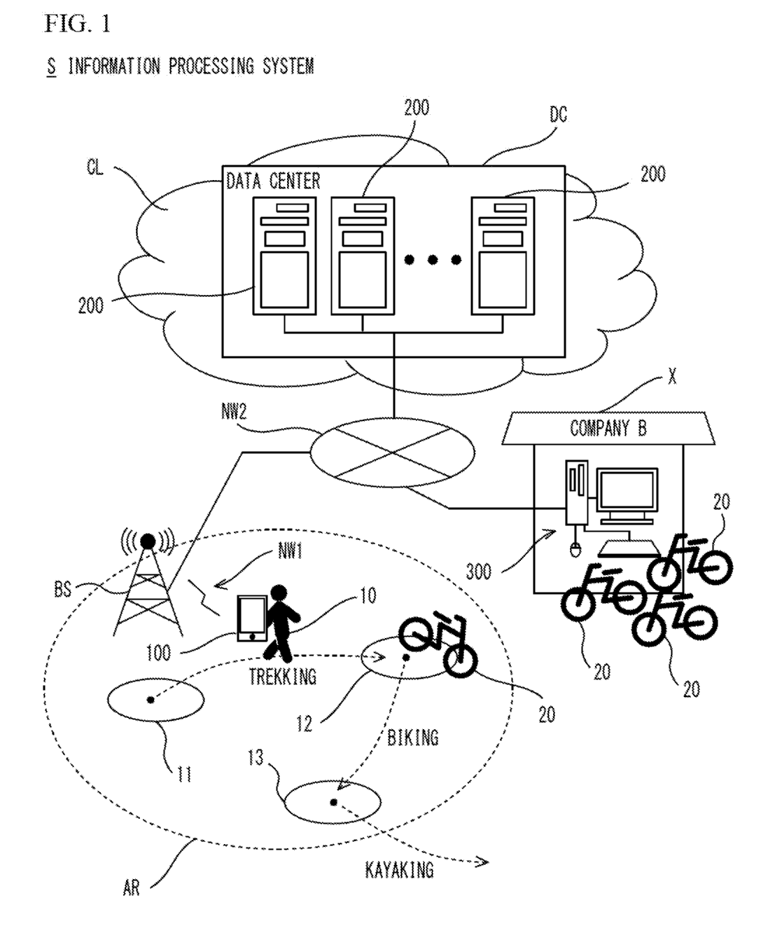

FIG. 1 is a diagram for describing an exemplary information processing system S. The information processing system S includes a user terminal 100, a management server 200, and a business operator terminal 300. In FIG. 1, a smartphone is illustrated as an example of the user terminal 100, but the user terminal 100 may be a tablet or a wearable device. That is, the user terminal 100 is a portable information processing device.

On the other hand, the management server 200 is a server installed in a data center DC on a cloud CL. Additionally, the business operator terminal 300 is a terminal device installed in a business office X of a business operator providing an activity (hereinafter, simply referred to as a business operator). In FIG. 1, a personal computer (PC) is illustrated as an example of the business operator terminal 300, but the business operator terminal 300 may be a smart device such as a smartphone or a tablet. The management server 200 may not be necessarily installed in the data center DC, and may be installed in a business office of a company or an organization aiming to promote the use of tourism resources.

The user terminal 100 and the management server 200 are interconnected via communication networks NW1 and NW2 when the user terminal 100 is included within the communicable region AR of a base station BS. The communication network NW1 is, for example, a Long Term Evolution (LTE) network, and the communication network NW2 is, for example, the Internet. As described above, the user terminal 100 can be connected to the management server 200 with use of wireless communication and wired communication. On the other hand, the management server 200 and the business operator terminal 300 are interconnected via the communication network NW2. In FIG. 1, the management server 200 and the business operator terminal 300 of a business operator “company B” are interconnected. The business operator terminals of business operators “company A” and “company C” described later are connected to the management server 200 as well as the business operator terminal 300 of the business operator “company B”, but these business operator terminals are omitted in FIG. 1.

As illustrated in FIG. 1, a user 10 conducts activities (more specifically, outdoor activities to enjoy the process of moving itself) in sequence while carrying the user terminal 100. In FIG. 1, as examples of activities, trekking, biking, and kayaking are presented. The user 10 selects these activities in advance. The user 10 moves from a departure place 11 for trekking to a via-location 12, which is the arrival place for trekking and is also the departure place for biking. When arriving at the via-location 12, the user 10 rides a bike 20 prepared by the business operator “company B”, and moves from the via-location 12 to a via-location 13, which is the arrival place for biking and the departure place for kayaking. When arriving at the via-location 13, the user 10 gets on a kayak (not illustrated) prepared by another business operator, and moves to the arrival place for kayaking.

The above-described business operator “company B” rents the bike 20 to the user 10 and provides a biking activity. The business operator “company B” prepares the bike 20 in the via-location 12 before the user 10 arrives at the via-location 12, and collects the bike 20 from the via-location 13 after the user 10 arrives at the via-location 13.

The above-described activities are not limited to trekking and the like, and may be canoeing and skiing as long as the activity is a particular activity that includes the move of the user 10 and of which the necessary time for the activity varies depending on the user 10. On the other hand, the activities to be conducted by the user 10 may include an activity, such as barbecue, fishing, or creation of a folk craft article, that does not involve the move of the user 10 and of which the necessary time may not vary depending on the user 10.

The details will be described later, but a plurality of geofences are set with respect to each of the via-locations 12 and 13 in the user terminal 100. For example, a circular first geofence, which defines a range with a radius of several kilometers to several tens of kilometers centered at the via-location 12, and a circular second geofence, which is concentric with the first geofence and is smaller than the first geofence, are set in the user terminal 100.

The user terminal 100 measures the position (more specifically, the latitude and the longitude) of the user 10 by using a Global Positioning System (GPS) function, and holds a first entry time of the user 10 when the measured position enters the first geofence. Furthermore, the user terminal 100 holds a second entry time of the user 10 when the measured position enters the second geofence, and generates speed information indicating the moving speed of the user 10 based on the difference between the second entry time and the first entry time and the length of the path along which the user 10 moved in the zone enclosed by the first geofence and the second geofence. The user terminal 100 then generates, based on time information indicating the time to give advance notice of expectation of arrival of the user 10 predetermined by the business operator “B” and the speed information, distance information corresponding to the time information, and sets a third geofence having a radius of the generated distance information. Since the third geofence is a circle centered at the via-location 12, the third geofence is a circle that is smaller than the first and second geofences and concentric with the first and second geofences.

When the measured position enters the third geofence, the user terminal 100 gives notice of expectation of arrival of the user 10 at the via-location 12 to the management server 200, and the management server 200 gives notice of expectation of arrival of the user 10 to the business operator terminal 300. Accordingly, the business operator “company B” is freed of the need to prepare the bike 20 within a very short time or deliver the bike 20 to the via-location 12 too early. As described above, preparation for accepting the user 10 by the business operator “company B” can be assisted. The description has been given of the via-location 12, but the same basically applies to the via-location 13.

Hereinafter, details of the information processing system S will be described.

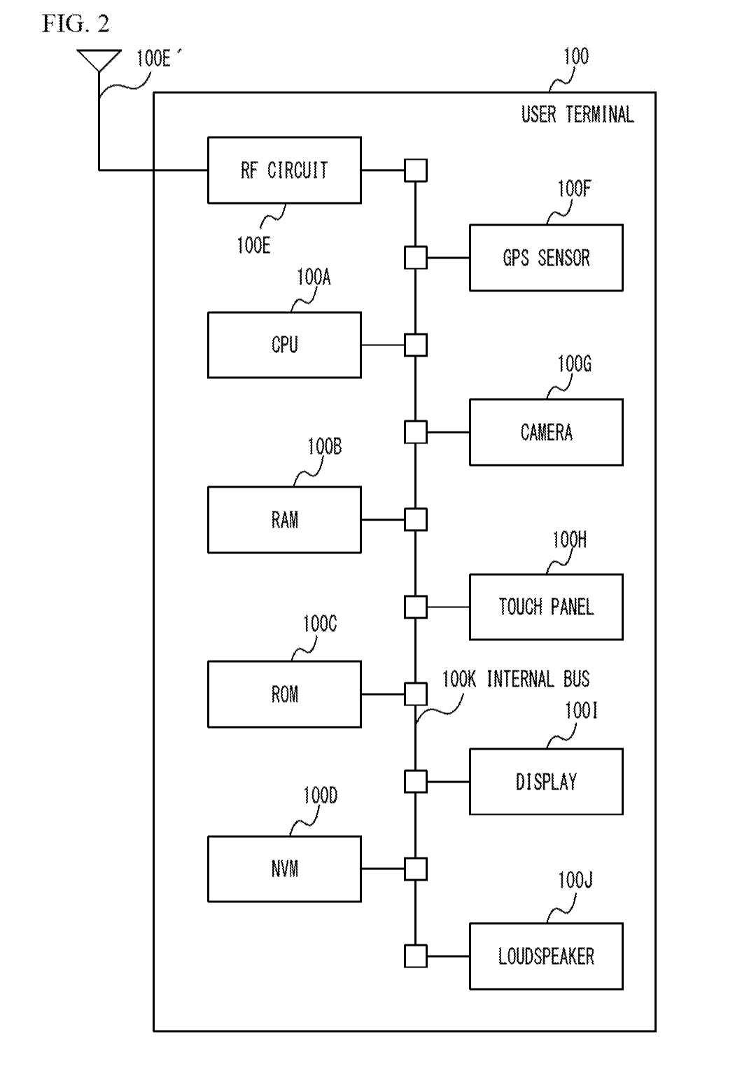

FIG. 2 illustrates an exemplary hardware configuration of the user terminal 100. As illustrated in FIG. 2, the user terminal 100 includes a central processing unit (CPU) 100A as a hardware processor, a random access memory (RAM) 100B, a read only memory (ROM) 100C, a non-volatile memory (NVM) 100D, and a radio frequency (RF) circuit 100E. The RF circuit 100E is coupled to an antenna 100E′. Instead of the RF circuit 100E, a CPU implementing a communication function may be used.

The user terminal 100 also includes a GPS sensor 100F, a camera 100G a touch panel 100H, a display 1001, and a loudspeaker 100J. The CPU 100A through the loudspeaker 100J are interconnected through an internal bus 100K. Cooperation between at least the CPU 100A and the RAM 100B implements the computer. Instead of the CPU 100A, a micro processing unit (MPU) may be used as a hardware processor.

The CPU 100A stores programs stored in the ROM 100C or the NVM 100D in the above-described RAM 100B. The execution of the stored programs by the CPU 100A allows the CPU 100A to implement various functions described later and execute various processes described later. It is sufficient if the program corresponds to a flowchart described later.

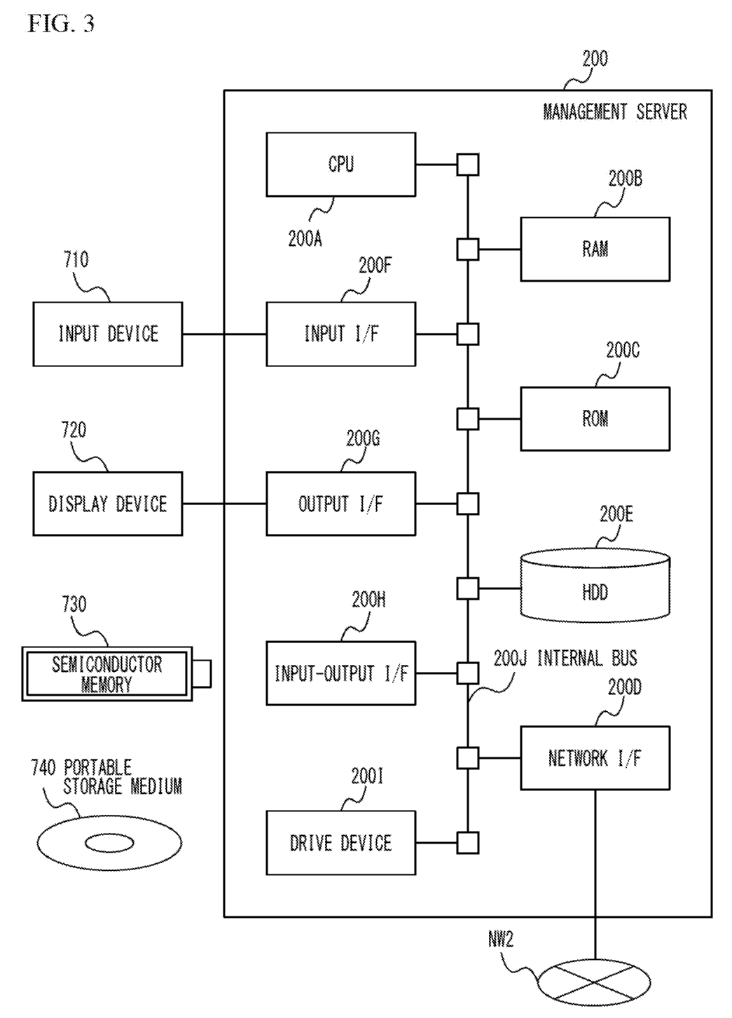

FIG. 3 illustrates an exemplary hardware configuration of the management server 200. The above-described business operator terminal 300 basically has the same hardware configuration as the management server 200, and the description thereof is thus omitted. As illustrated in FIG. 3, the management server 200 includes at least a CPU 200A as a hardware processor, a RAM 200B, a ROM 200C, and a network I/F 200D. The management server 200 may include at least one of a hard disk drive (HDD) 200E, an input I/F (interface) 200F, an output I/F 200G, an input-output I/F 200H, and a drive device 200I as necessary. The CPU 200A through the drive device 200I are interconnected through an internal bus 200J. The cooperation between at least the CPU 200A and the RAM 200B implements the computer. Instead of the CPU 200A, the above-described MPU may be used as a hardware processor.

An input device 710 is coupled to the input I/F 200F. Examples of the input device 710 include, but are not limited to, a keyboard and a mouse. A display device 720 is coupled to the output I/F 200G. Examples of the display device 720 include, but are not limited to, a liquid crystal display. A semiconductor memory 730 is coupled to the input-output I/F 200H. Examples of the semiconductor memory 730 include, but are not limited to, a Universal Serial Bus (USB) memory and a flash memory. The input-output I/F 200H reads programs and data stored in the semiconductor memory 730. The input I/F 200F and the input-output I/F 200H have, for example, a USB port. The output I/F 200G has, for example, a display port.

A portable storage medium 740 is inserted into the drive device 200I. Examples of the portable storage medium 740 include, but are not limited to, removal discs such as a compact disc (CD)-ROM and a digital versatile disc (DVD). The drive device 200I reads programs and data stored in the portable storage medium 740. The network I/F 200D has, for example, a LAN port. The network I/F 200D is coupled to the above-described communication network NW2.

The CPU 200A stores the program stored in the ROM 200C or the HDD 200E in the above-described RAM 200B. The CPU 200A stores the program stored in the portable storage medium 740 in the RAM 200B. The execution of the stored program by the CPU 200A allows the CPU 200A to implement various functions described later and execute various processes described later. It is sufficient if the program corresponds to a flowchart described later.

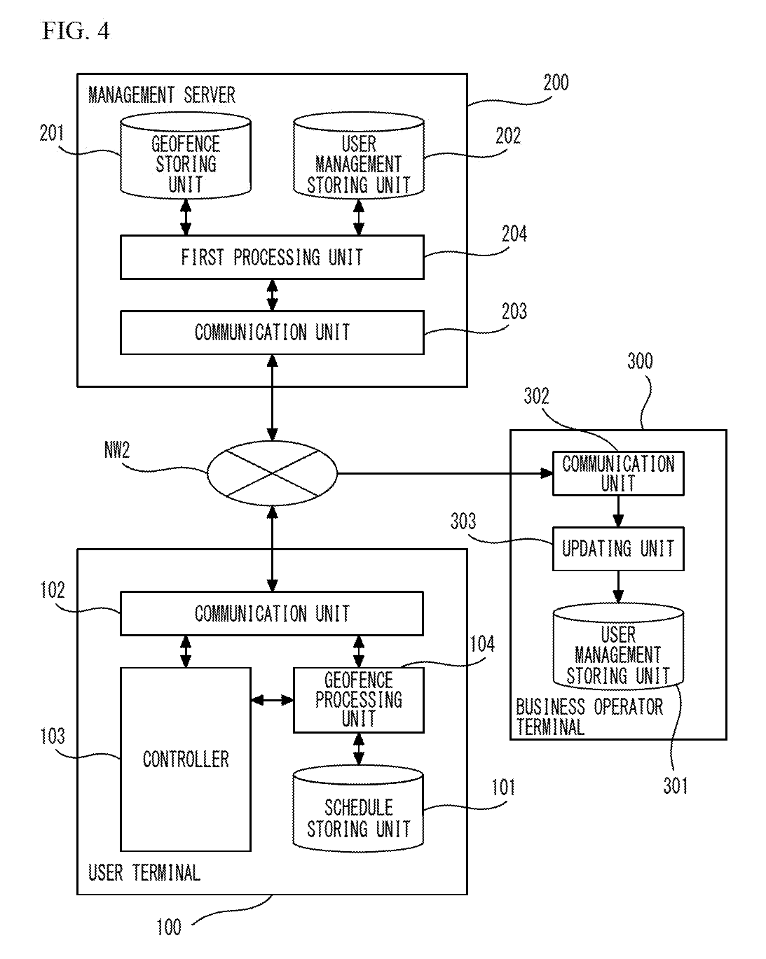

FIG. 4 is an exemplary block diagram of the user terminal 100, the management server 200, and the business operator terminal 300 in accordance with the first embodiment. In particular, FIG. 4 illustrates functional configurations of the user terminal 100, the management server 200, and the business operator terminal 300.

First, the user terminal 100 will be described. The user terminal 100 includes, as illustrated in FIG. 4, a schedule storing unit 101, a communication unit 102, a controller 103, and a geofence processing unit 104 as a processor described later. The schedule storing unit 101 is implemented by, for example, the above-described NVM 100D. The communication unit 102 is implemented by, for example, the RF circuit 100E and the antenna 100E′ described above. The controller 103 and the geofence processing unit 104 are implemented by, for example, the CPU 100A and the RAM 100B described above.

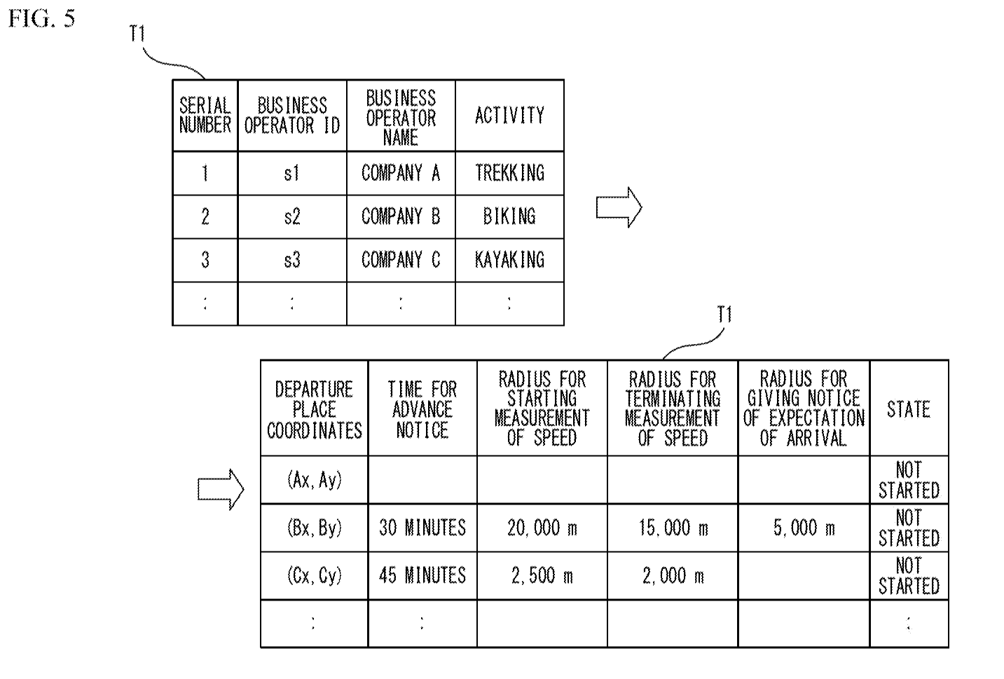

The schedule storing unit 101 stores schedule information in which each of activities selected by the user 10 in advance is related to a geofence relevant to each activity and the like. The schedule information is managed with a schedule table T1 as illustrated in FIG. 5. The schedule table T1 includes composition elements such as a serial number, a business operator ID, a business operator name, an activity, departure place coordinates, time for advance notice, a radius for starting measurement of speed, a radius for terminating measurement of speed, a radius for giving notice of expectation of arrival, and a state.

Here, the serial numbers identify activities to be conducted by the user 10, and represent the schedule defining the execution order of the activities. The schedule specifies the execution order of the activities to be conducted by the user 10. The business operator ID and the business operator name represent the identification information for identifying the business operator and the name of the business operator, respectively. The activity represents the specific name of the activity. The departure place coordinates represent positional coordinates of the departure place 11 from which the user 10 departs and positional coordinates of the via-locations 12 and 13 (see FIG. 1). The departure place coordinates correspond to the center of the first geofence, the second geofence, and the third geofence. The time for advance notice represents the time to give advance notice of expectation of arrival of the user 10 at each of the via-locations 12 and 13. The time for advance notice is predetermined by each business operator. The time for advance notice is preferably time sufficient for the business operator to conduct a preparatory work in consideration of attributes (e.g., sex, age, the presence or absence of experience of the activity) of the user 10.

The radius for starting measurement of speed, the radius for terminating measurement of speed, and the radius for giving notice of expectation of arrival represent the radius of the first geofence, the radius of the second geofence, and the radius of the third geofence, respectively. Thus, the ranges of the circular first geofence, the circular second geofence, and the circular third geofence are defined by the above-described departure place coordinates, the radius for starting measurement of speed, the radius for terminating measurement of speed, and the radius for giving notice of expectation of arrival. The radius for starting measurement of speed and the radius for terminating measurement of speed are predetermined by each business operator. In particular, the radius for starting measurement of speed and the radius for terminating measurement of speed are preferably not the radius for measuring the speed immediately after the user 10 starts an activity. It is expected that the user 10 is not tired and moves fast immediately after the user 10 starts an activity, but as the activity progresses, the moving speed of the user 10 decreases due to fatigue. Thus, it is preferable to predict the radius for giving notice of expectation of arrival registered later and set a radius slightly greater than the radius for giving notice of expectation of arrival. This configuration makes the moving speed in the remaining path to the via-location 12 from the location at which a notice of expectation of arrival is given according to the actual fatigue of the user 10. The state is information indicating whether the user 10 has started the activity, whether the user 10 is conducting the activity, or whether the user 10 has finished the activity. As illustrated in FIG. 5, the time for advance notice, the radius for starting measurement of speed, the radius for terminating measurement of speed, and the radius for giving notice of expectation of arrival of the schedule information identified by the activity “trekking” may not be necessarily registered. This is because in the present embodiment, the business operator “company A”, which provides the first activity, is not required to give notice of expectation of arrival of the user 10.

The communication unit 102 illustrated in FIG. 4 controls the communication between the user terminal 100 and the management server 200. For example, the communication unit 102 receives various information and notices output from the controller 103 or the geofence processing unit 104, and transmits them to the management server 200. For example, the communication unit 102 receives various information transmitted from the management server 200, and outputs the received information to the controller 103 and the geofence processing unit 104.

The controller 103 controls the entire operation of the user terminal 100 based on an operating system (OS: basic software). For example, when accepting an instruction to start the activity from the user 10, the controller 103 measures the position of the user 10 periodically by using a GPS function, and outputs the measured position to the geofence processing unit 104.

The geofence processing unit 104 determines the entering of the user 10 into the first geofence, the second geofence, and the third geofence based on the information related to the geofences in the schedule information stored in the schedule storing unit 101 and the position of the user 10 output from the controller 103. For example, when determining that the user 10 has entered the second geofence after the user 10 entered the first geofence, the geofence processing unit 104 generates the speed information indicating the moving speed of the user 10 and generates the distance information indicating the radius of the third geofence. For example, when determining that the user 10 has entered the third geofence, the geofence processing unit 104 gives notice of expectation of arrival of the user 10 to the management server 200. The geofence processing unit 104 executes other various processes, but the details of the processes will be described later.

Next, the management server 200 will be described. The management server 200 includes, as illustrated in FIG. 4, a geofence storing unit 201, a user management storing unit 202, a communication unit 203, and a first processing unit 204. The geofence storing unit 201 and the user management storing unit 202 are implemented by, for example, the above-described HDD 200E. The communication unit 203 is implemented by, for example, the above-described network I/F 200D. The first processing unit 204 is implemented by, for example, the CPU 200A and the RAM 200B described above.

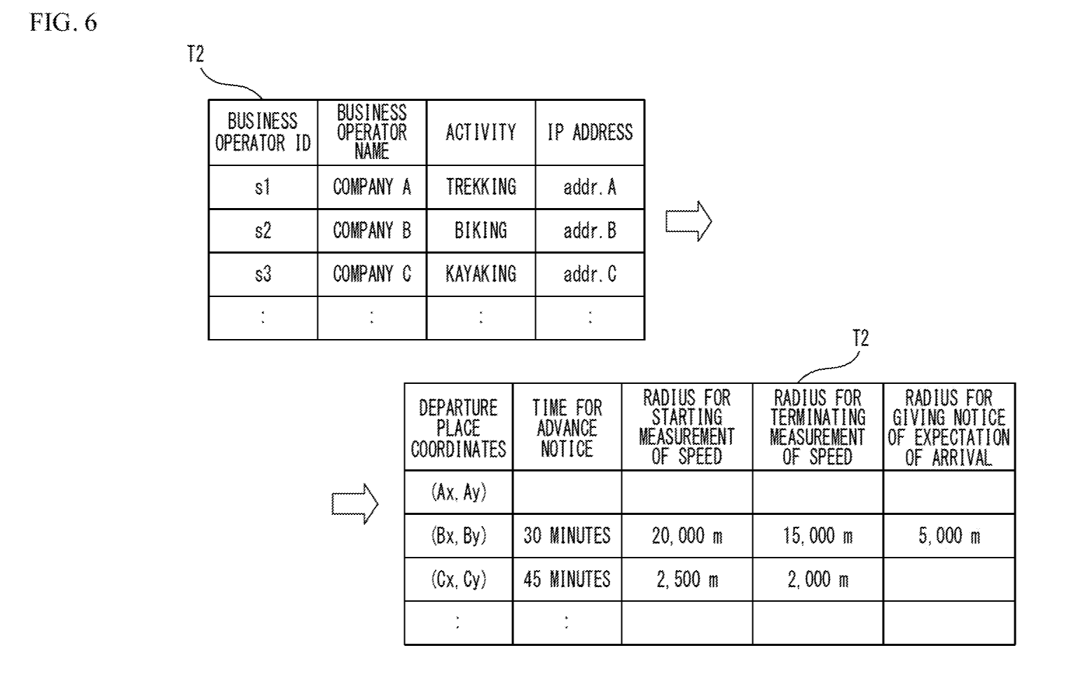

The geofence storing unit 201 stores geofence information in which the time for advance notice and the geofence determined with respect to each business operator are related to each business operator. The geofence information is managed with a geofence table T2 as illustrated in FIG. 6. The geofence table T2 includes composition elements such as a business operator ID, a business operator name, an activity, an Internet Protocol (IP) address, departure place coordinates, time for advance notice, a radius for starting measurement of speed, a radius for terminating measurement of speed, and a radius for giving notice of expectation of arrival. That is, the above-described schedule information (see FIG. 5) includes part of the geofence information. In other words, the part of the schedule information is included in the geofence information.

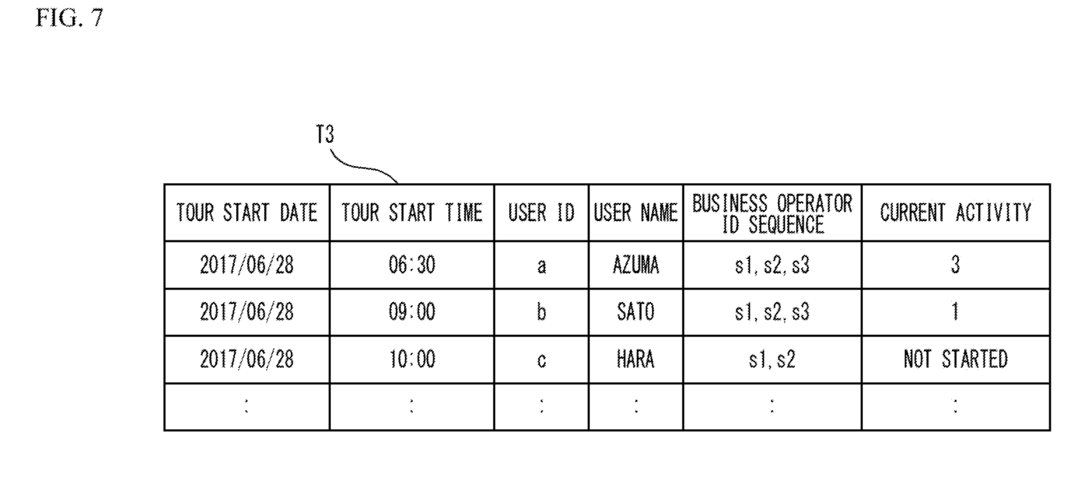

The user management storing unit 202 stores user management information for managing activities to be conducted by the user 10 who signed up for the tour, the current status of the user 10 who is conducting (or experiencing) the activity, and the like. The user management information is managed with a user management table T3 as illustrated in FIG. 7. The user management table T3 includes composition elements such as a tour start date, tour start time, a user ID, a user name, a business operator ID sequence, and a current activity.

The tour start date and the tour start time represent the date and the time to start the tour including activities, respectively. The user ID and the user name represent the identification information of the user 10 and a part (family name) of the full name of the user 10, respectively. The business operator ID sequence represents the business operator IDs of the business operators providing the activities for which the user 10 signed up in order in which the activities are to be provided. The current activity indicates the serial number of the activity being currently conducted by the user 10.

The communication unit 203 illustrated in FIG. 4 controls the communication among the user terminal 100, the management server 200, and the business operator terminal 300. For example, the communication unit 203 accepts various information and notices output from the first processing unit 204, and transmits them to the user terminal 100 and the business operator terminal 300. For example, the communication unit 203 receives various information and notices transmitted from the user terminal 100, and outputs them to the first processing unit 204.

The first processing unit 204 executes various processes based on the information output from the communication unit 203. For example, when detecting the registration of the activity to be conducted by the user 10 from the user terminal 100, the first processing unit 204 specifies the business operator providing the activity. Then, the first processing unit 204 transmits the user management information on the user 10 to the specified business operator. In addition, when detecting the above-described registration, the first processing unit 204 generates the schedule information indicating the schedule of the activity, and transmits the generated schedule information to the user terminal 100. Furthermore, when receiving a notice of entry into the third geofence from the communication unit 203, the first processing unit 204 specifies the business operator to which the notice of the entry into the third geofence is to be given based on the received notice, and gives notice of expectation of arrival of the user 10 to the specified business operator.

Next, the business operator terminal 300 will be described. The business operator terminal 300 includes, as illustrated in FIG. 4, a user management storing unit 301, a communication unit 302, and an updating unit 303. The user management storing unit 301 is implemented by, for example, the above-described HDD 200E. The communication unit 302 is implemented by, for example, the above-described network I/F 200D. The updating unit 303 is implemented by, for example, the CPU 200A and the RAM 200B described above.

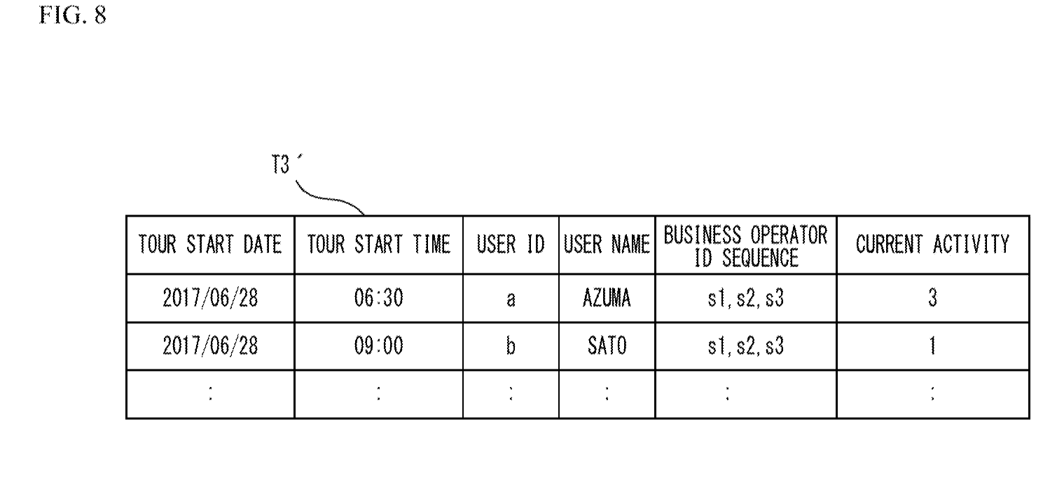

The user management storing unit 301 stores the user management information transmitted from the management server 200. The user management information is managed with a user management table T3′ as illustrated in FIG. 8. The user management table T3′ is basically the same as the user management table T3 described with reference to FIG. 7. However, the user management storing unit 301 of the business operator having the business operator ID registered in the business operator ID sequence stores the user management information on the user 10 who is to conduct the activity provided by the business operator. That is, for example, the user management information of which the user ID is “c” indicates that the user 10 whose user ID is “c” does not have a plan to conduct the activity provided by the business operator of which the business operator ID is “s3”. Thus, as illustrated in FIG. 8, the user management storing unit 301 of the business operator of which the business operator ID is “s3” does not store the user management information of which the user ID is “c”.

The communication unit 302 illustrated in FIG. 4 controls the communication between the management server 200 and the business operator terminal 300. For example, the communication unit 302 receives a notice transmitted from the management server 200, and outputs the received notice to the updating unit 303. The updating unit 303 accepts the notice output from the communication unit 302, and displays expectation of arrival of the user 10 on a screen, or updates the user management information managed by the user management storing unit 301.

Next, the operation of the information processing system S will be described.

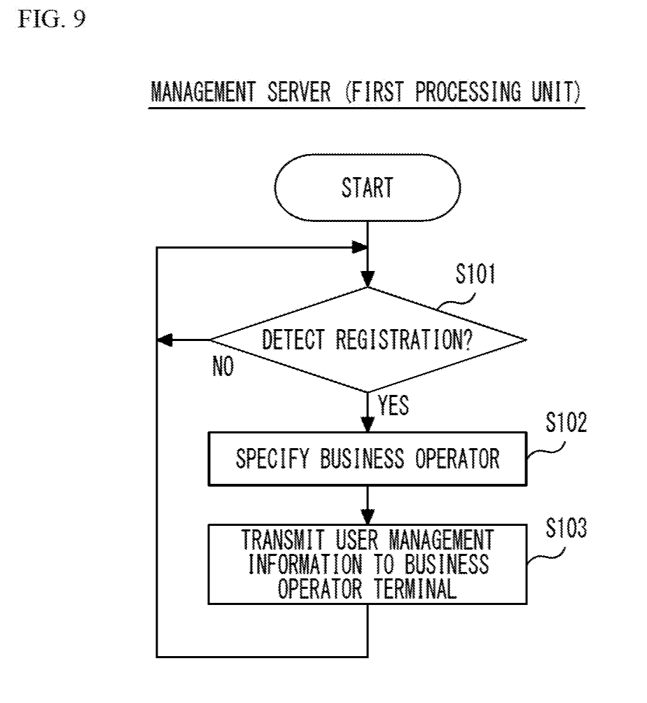

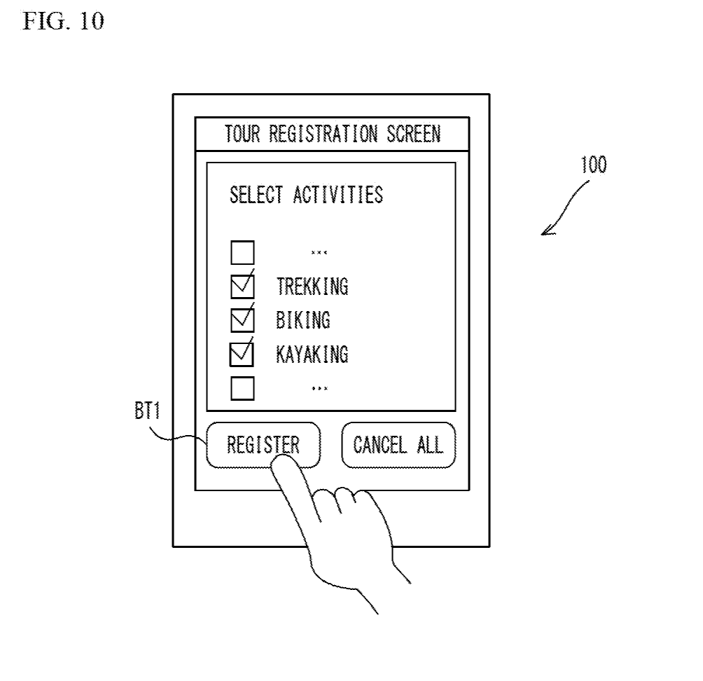

With reference to FIG. 9 and FIG. 10, a process executed by the first processing unit 204 will be described. As illustrated in FIG. 9, the first processing unit 204 waits until detecting the registration of a tour (step S101: NO). When detecting the registration of a tour (step S101: YES), the first processing unit 204 specifies the business operator (step S102). In more detail, as illustrated in FIG. 10, on the day prior to the day of the tour, the user 10 operates the user terminal 100 to select activities that the user 10 plans to conduct from among a plurality of activities, and presses a registration button BT1. This operation causes the first processing unit 204 to detect the registration of a tour.

When detecting the registration, the first processing unit 204 accesses the geofence storing unit 201 (see FIG. 6), specifies the business operators providing activities included in the tour, and generates the business operator ID sequence based on the business operator IDs of the specified business operators. After generating the business operator ID sequence, the first processing unit 204 relates the generated business operator ID sequence to the information on (more specifically, the user ID and the user name of) the user 10 who operated the user terminal 100 and the tour start date and time, and stores it as the user management information in the user management storing unit 202 (see FIG. 7). Immediately after the user management information is stored, the tour has not started yet. Thus, the flag “not started” is registered in the column of the current activity. Alternatively, the user terminal 100 may have information related to the tour registration screen displayed on the user terminal 100. Yet alternatively, the management server 200 may have the information related to the tour registration screen, and when the user terminal 100 is operated by the user 10, the user terminal 100 may obtain the information related to the tour registration screen from the management server 200 based on the operation.

On completion of the process at step S102, the first processing unit 204 transmits the user management information to the business operator terminal 300 (step S103), and returns to the process at step S101. In more detail, the first processing unit 204 obtains the IP address of the business operator specified in the process at step S102, and transmits the user management information to the business operator terminal 300 of the business operator to which the obtained IP address is assigned. For example, when the user 10 whose user name is “Sato” registered a tour, since activities “trekking”, “biking”, and “kayaking” are selected (see FIG. 7), the first processing unit 204 transmits the user management information of which the user name is “Sato” to the business operator terminal 300 of each of the business operators “company A”, “company B”, and “company C”. This process causes the user management storing unit 301 of each business operator terminal 300 to store the user management information of which the user name is “Sato” (see FIG. 8). Alternatively, the updating unit 303 of each business operator terminal 300 may periodically check with the management server 200 whether new user management information indicating participation to the activity provided by the business operator is added, and when the new user management information is added, the updating unit 303 may obtain the user management information.

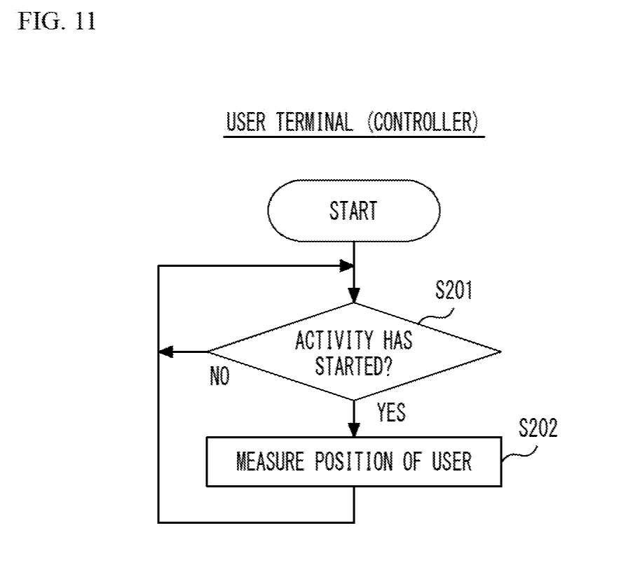

With reference to FIG. 11 through FIG. 14D, processes executed by the controller 103 and the geofence processing unit 104 will be described. As illustrated in FIG. 11, the controller 103 waits until the activity starts (step S201: NO). When the activity has started (step S201: YES), the controller 103 measures the position of the user 10 (step S202), and returns to the process at step S201.

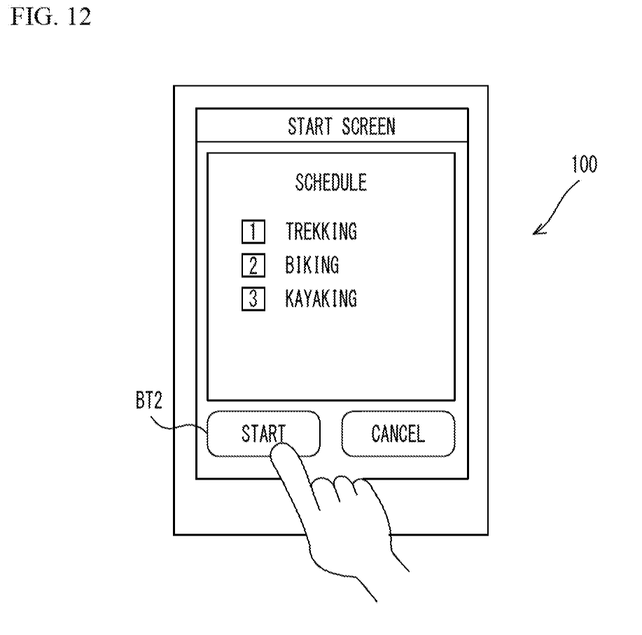

In more detail, as illustrated in FIG. 12, on the day of the tour, the user terminal 100 displays the activities included in the tour registered in advance and a start button BT2 for starting the activity. The user 10 operates the user terminal 100 to press the start button BT2 at the departure place 11 (see FIG. 1). This operation causes the controller 103 to determine that the activity has started, start measuring the position of the user 10, and periodically output the measured position to the geofence processing unit 104.

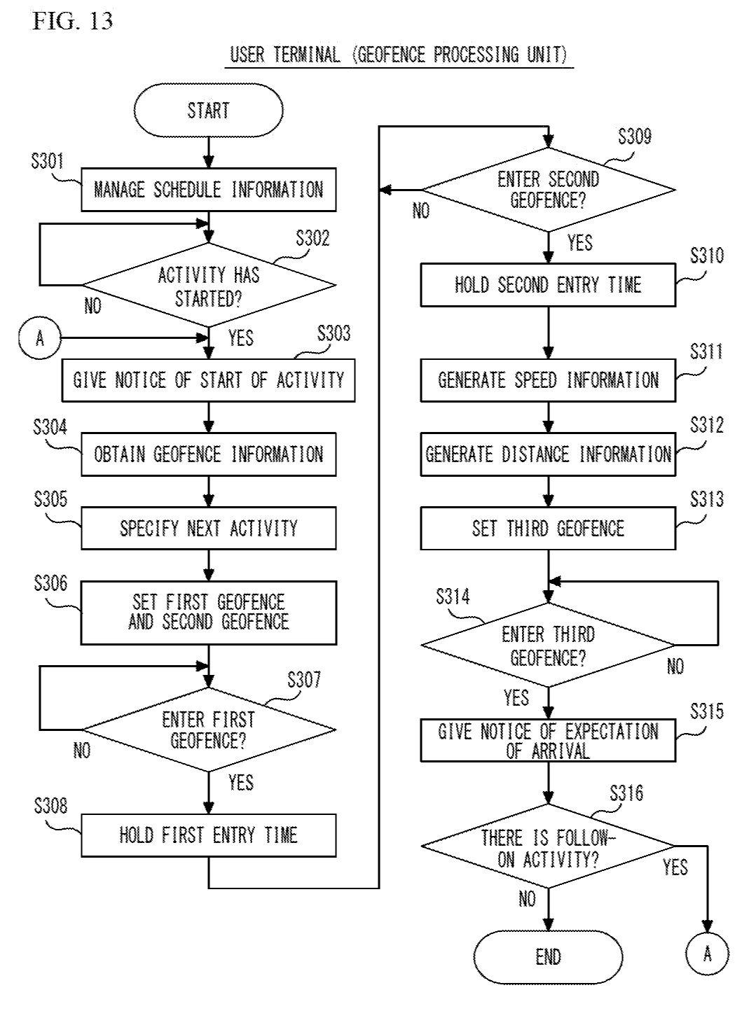

On the other hand, as illustrated in FIG. 13, the geofence processing unit 104 manages the schedule information (step S301). In more detail, when detecting the above-described registration of the tour, the geofence processing unit 104 manages the schedule information related to the registered tour. In particular, the geofence processing unit 104 manages the schedule information that includes the execution order of the activities, the business operator IDs and the business operator names of the business operators providing the activities, and the names of the selected activities, and does not include the remaining composition elements such as the departure place coordinates and the time for advance notice (see FIG. 5).

On completion of the process at step S301, the geofence processing unit 104 then waits until the activity starts (step S302: NO). When the activity has started (step S302: YES), the geofence processing unit 104 gives notice of the start of the activity to the management server 200 (step S303), and obtains the geofence information (step S304).

In more detail, when the activity has started, the geofence processing unit 104 gives notice of the start of the activity together with the business operator ID corresponding to the started activity and the user ID of the user 10. When the geofence processing unit 104 gives notice of the start of the activity, the first processing unit 204 of the management server 200 extracts the departure place coordinates, the time for advance notice, the radius for starting measurement of speed, and the radius for terminating measurement of speed of all the activities included in the tour from the geofence storing unit 201 based on the notice and holds them. Then, the geofence processing unit 104 obtains the departure place coordinates, the time for advance notice, the radius for starting measurement of speed, and the radius for terminating measurement of speed held by the first processing unit 204, and registers them in the corresponding schedule information. This process registers the departure place coordinates, the time for advance notice, the radius for starting measurement of speed, and the radius for terminating measurement of speed of each of the activities “biking” and “kayaking” in the schedule table T1. At this time, the radius for giving notice of expectation of arrival is not registered yet.

On completion of the process at step S304, the geofence processing unit 104 specifies the next activity (step S305). In more detail, the geofence processing unit 104 specifies the next activity based on the schedule information stored in the schedule storing unit 101. For example, the geofence processing unit 104 checks the states in the schedule information, specifies the serial numbers corresponding to the states in which the flag “not started”, which indicates that the activity is not started yet, is registered, and specifies the activity corresponding to the smallest serial number among the specified serial numbers. In the present embodiment, the geofence processing unit 104 specifies the activity “biking”. When detecting the start of the activity conducted by the user 10, the geofence processing unit 104 updates the state in the schedule information with the flag “started”, and when detecting the end of the activity conducted by the user 10, updates the state in the schedule information with the flag “conducted”.

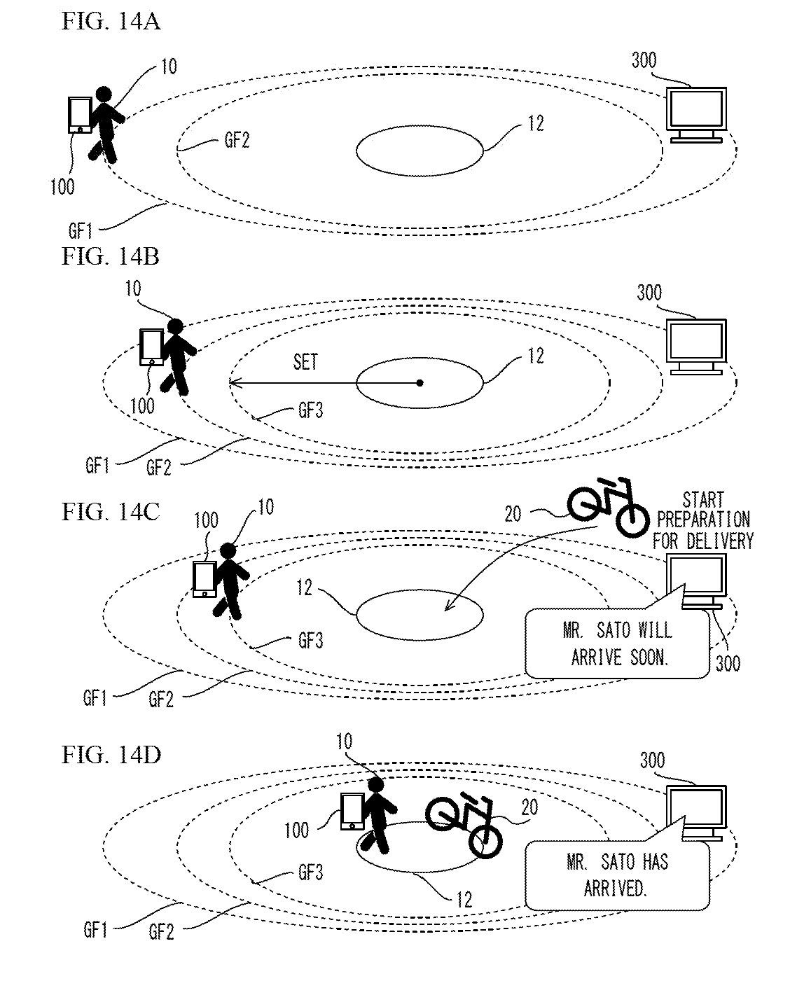

On completion of the process at step S305, the geofence processing unit 104 sets the first geofence and the second geofence (step S306). In more detail, the geofence processing unit 104 sets the first geofence based on the departure place coordinates and the radius for starting measurement of speed of the next activity specified in the process at step S306, and sets the second geofence based on the departure place coordinates and the radius for terminating measurement of speed of the specified next activity. Accordingly, as illustrated in FIG. 14A, a first geofence GF1 and a second geofence GF2 are virtually set in the user terminal 100.

On completion of the process at step S306, the geofence processing unit 104 waits until the user 10 enters the first geofence (step S307: NO). When the user 10 has entered the first geofence (step S307: YES), the geofence processing unit 104 holds the first entry time indicating the entry time to the first geofence (step S308). For example, as illustrated in FIG. 14A, when the user 10 enters the first geofence GF1, the geofence processing unit 104 holds the first entry time since the position of the user 10 output from the controller 103 belongs to the first geofence GF1.

On completion of the process at step S308, the geofence processing unit 104 waits until the user 10 enters the second geofence (step S309: NO). When the user 10 has entered the second geofence (step S309: YES), the geofence processing unit 104 holds the second entry time indicating the entry time to the second geofence (step S310). For example, as illustrated in FIG. 14B, when the user 10 enters the second geofence GF2, the geofence processing unit 104 holds the second entry time since the position of the user 10 output from the controller 103 belongs to the second geofence GF2.

On completion of the process at step S310, the geofence processing unit 104 generates the speed information (step S311). In more detail, the geofence processing unit 104 generates the speed information indicating the moving speed of the user 10 based on the difference between the second entry time and the first entry time and the length of the path along which the user 10 moved in the zone enclosed by the first geofence and the second geofence.

On completion of the process at step S311, the geofence processing unit 104 generates the distance information (step S312). In more detail, the geofence processing unit 104 extracts the time information indicating the time for advance notice of the next activity specified in the process at step S305 from the schedule storing unit 101, and generates the distance information corresponding to the time information based on the extracted time information and the speed information generated in the process at step S311. When generating the distance information, the geofence processing unit 104 registers the distance specified by the distance information in the radius for giving notice of expectation of arrival of the schedule information (see FIG. 5). The geofence processing unit 104 may transmit the distance information to the management server 200. The first processing unit 204 may register the distance specified by the distance information in the radius for giving notice of expectation of arrival of the geofence information (see FIG. 6).

On completion of the process at step S312, the geofence processing unit 104 sets the third geofence (step S313). In more detail, the geofence processing unit 104 sets the third geofence based on the departure place coordinates of the next activity specified in the process at step S305 and the distance specified by the distance information generated in the process at step S312. Accordingly, as illustrated in FIG. 14B, a third geofence GF3 is virtually set in the user terminal 100.

On completion of the process at step S313, the geofence processing unit 104 waits until the user 10 enters the third geofence (step S314: NO). When the user 10 has entered the third geofence (step S314: YES), the geofence processing unit 104 gives notice of expectation of arrival (step S315). For example, as illustrated in FIG. 14C, when the user 10 has entered the third geofence GF3, the geofence processing unit 104 determines that the position of the user 10 output from the controller 103 belongs to the third geofence GF3, and gives notice of expectation of arrival at the via-location 12 to the management server 200 together with the business operator ID of the business operator corresponding to the next activity and the user ID. When the geofence processing unit 104 gives notice of expectation of arrival, the notice of expectation of arrival is displayed on the screen of the business operator terminal 300. Accordingly, the operator of the business operator “company B” starts preparation for delivering the bike 20 to the via-location 12.

On completion of the process at step S315, the geofence processing unit 104 determines whether there is a follow-on activity (step S316). In more detail, when the process at step S315 was completed and the user 10 has arrived at the via-location 12 as illustrated in FIG. 14D, the geofence processing unit 104 gives notice of arrival to the management server 200 because the position of the user 10 output from the controller 103 belongs to the region specifying the via-location 12. The geofence processing unit 104 gives notice of arrival and updates the schedule information (in more detail, the state), and then determines whether there is a follow-on activity. In the present embodiment, the geofence processing unit 104 updates the state of the activity “trekking” from the flag “started” to the flag “conducted” (see FIG. 5).

When determining that there is a follow-on activity (step S316: YES), the geofence processing unit 104 returns to the process at step S302. In more detail, the geofence processing unit 104 checks the states in the schedule information, specifies the smallest serial number of the serial numbers corresponding to the states in which the flag “not started” is registered, and returns to the process at step S303 when there is an activity corresponding to the specified serial number. On the other hand, when determining that there is no follow-on activity (step S316: NO), the geofence processing unit 104 ends the process. In more detail, the geofence processing unit 104 checks the states in the schedule information, and ends the process when there is no activity corresponding to the state in which the flag “not started” is registered.

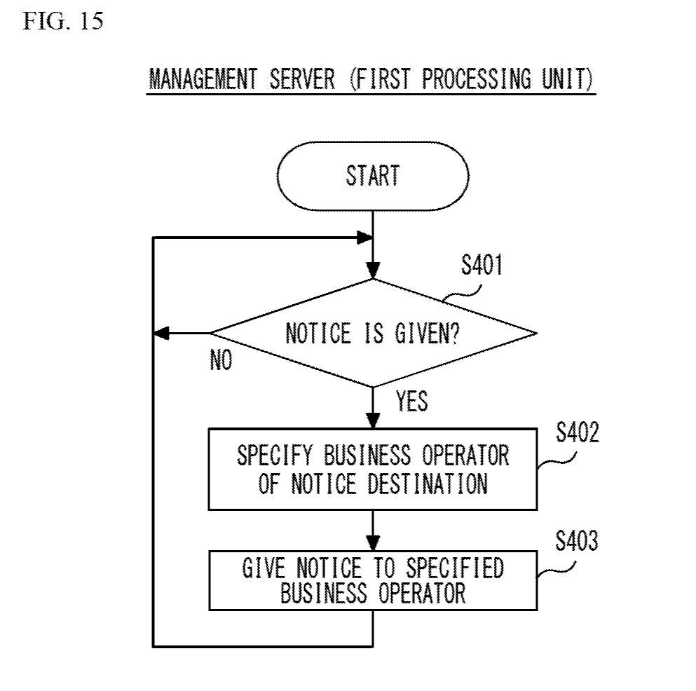

Next, with reference to FIG. 15, another process executed by the first processing unit 204 will be described. As illustrated in FIG. 15, the first processing unit 204 waits until a notice is given (step S401: NO). The notice may be a notice of the start of an activity, a notice of expectation of arrival, or a notice of arrival. When a notice is given (step S401: YES), the first processing unit 204 specifies the business operator of the notice destination (step S402). For example, when the notice is a notice of the start of an activity, the first processing unit 204 specifies, based on the business operator ID given together with the notice, the business operator having the given business operator ID as the business operator of the notice destination. On the other hand, when the notice is a notice of expectation of arrival, the first processing unit 204 specifies, based on the business operator ID given together with the notice of expectation of arrival, the business operator having the given business operator ID and providing the next activity as the business operator of the notice destination.

On completion of the process at step S402, the first processing unit 204 gives notice of the start of an activity or expectation of arrival to the specified business operator (step S403). In more detail, on completion of the process at step S402, the first processing unit 204 updates the current activity in the user management information based on the type of the notice, and then gives notice of the start of an activity or expectation of arrival to the business operator. For example, when the notice is a notice of the start of an activity, the first processing unit 204 specifies the business operator ID sequence in the user management information based on the user ID, and updates the current activity with the serial number of the started activity based on the business operator ID and the specified business operator ID sequence. When the notice is a notice of expectation of arrival, the first processing unit 204 maintains the current activity. When the notice is a notice of arrival, the first processing unit 204 specifies the business operator ID sequence in the user management information based on the user ID, and updates the current activity with the flag “conducted” based on the business operator ID and the specified business operator ID sequence. After the first processing unit 204 finishes such updates, the first processing unit 204 gives notice of the start of an activity or expectation of arrival to the business operator together with the user ID and the business operator ID.

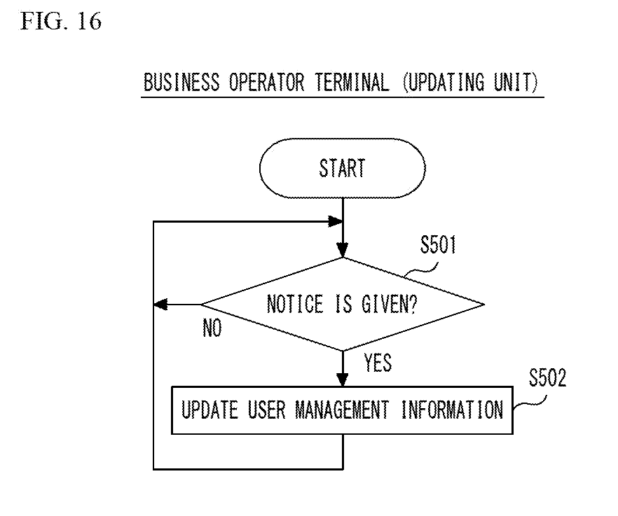

Next, with reference to FIG. 16, a process executed by the updating unit 303 of the business operator terminal 300 will be described. As illustrated in FIG. 16, the updating unit 303 waits until a notice is given (step S501: NO). The notice may be a notice of the start of an activity or a notice of expectation of arrival. When a notice is given (step S501: YES), the updating unit 303 updates the user management information (step S502). For example, when the notice is a notice of the start of an activity, the updating unit 303 specifies the business operator ID sequence in the user management information based on the user ID, and updates the current activity with the serial number of the started activity based on the business operator ID and the specified business operator ID sequence. When the notice is a notice of expectation of arrival, the first processing unit 204 maintains the current activity, and displays expectation of arrival on the screen. When the notice is a notice of arrival, the updating unit 303 specifies the business operator ID sequence in the user management information based on the user ID, and updates the current activity with the flag “conducted” based on the business operator ID sequence and the specified business operator ID sequence. After finishing these processes, the updating unit 303 returns to the process at step S501.

As described above, in the first embodiment, the user terminal 100 includes the geofence processing unit 104. The geofence processing unit 104 manages the schedule information including the execution order of activities to be conducted by the user 10. When the geofence processing unit 104 has managed the schedule information, the geofence processing unit 104 obtains the geofence information including the positional information indicating the departure place of each activity of the activities and the time information indicating the time to give advance notice of expectation of arrival of the user 10 at the departure place for the next activity to the business operator terminal 300 of the business operator providing the next activity of each activity. The geofence processing unit 104 specifies the next activity to be conducted by the user 10 based on the managed schedule information.

When the geofence processing unit 104 specifies the next activity, the geofence processing unit 104 generates, based on the time information in the geofence information corresponding to the specified next activity and the speed information indicating the speed at which the user 10 moves, the distance information corresponding to the time information. Then, the geofence processing unit 104 indirectly gives notice of expectation of arrival of the user 10 at the departure place for the specified next activity to the business operator terminal 300 of the business operator providing the specified next activity based on entering of the user 10 into the third geofence GF3 defined based on the positional information in the geofence information corresponding to the specified next activity and the generated distance information. This configuration enables to assist preparation for accepting the user by the business operator.

Particularly, in the first embodiment, the radius of the third geofence GF3 dynamically changes according to the moving speed of the user 10. For example, it may be considered to use geofencing to give notice of expectation of arrival of the user 10 when the user 10 enters the third geofence GF3 with a fixed or unchanged radius of 10 km around the via-location 12 at which the next activity is started. However, in this case, the business operator may not be able to smoothly start preparation for accepting the user.

For example, expectation of arrival may vary depending on the athletic ability of the user 10 or the experience or technique (e.g., walking technique, running technique, and rowing technique) of the activity of the user 10, and thus, the business operator may not be able to correctly know expectation of arrival of the user 10. In addition to the athletic ability of the user 10 or the experience or technique of the activity, expectation of arrival may vary depending on the weather on the day of the tour. As described above, in the case where the execution period of the activity differs among the users 10 and the user 10 conducts a particular activity that has characteristics that the process of moving is included in the activity, the business operator may not be able to smoothly start preparation for accepting the user.

However, in the first embodiment, since the radius of the third geofence GF3 dynamically changes according to the moving speed of the user 10, the business operator can smoothly start preparation for accepting the user regardless of the athletic ability of the user 10. As a result, preparation for accepting the user by the business operator can be assisted.

### Second Embodiment

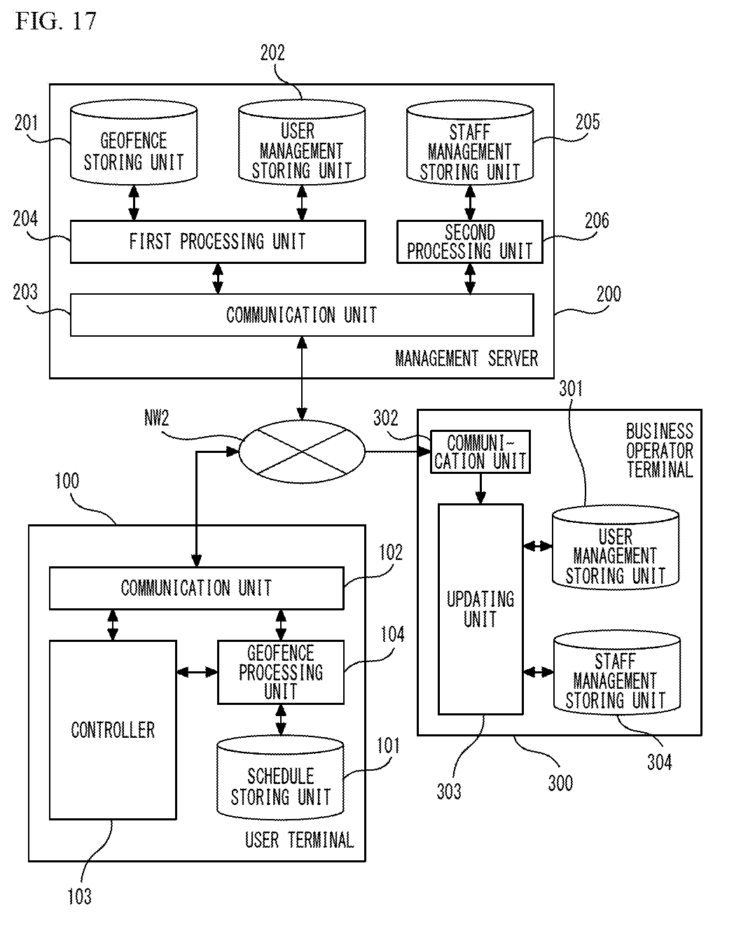

A description will next be given of a second embodiment. FIG. 17 is an exemplary block diagram of the user terminal 100, the management server 200, and the business operator terminal 300 in accordance with the second embodiment. FIG. 17 illustrates functional configurations of the user terminal 100, the management server 200, and the business operator terminal 300. The same reference numerals are affixed to the same components as those of the user terminal 100, the management server 200, and the business operator terminal 300 in accordance with the first embodiment described with reference to FIG. 4, and the description thereof is omitted.

As illustrated in FIG. 17, the management server 200 in accordance with the second embodiment differs from the management server 200 of the first embodiment in that a staff management storing unit 205 and a second processing unit 206 are provided. The business operator terminal 300 of the second embodiment differs from the business operator terminal 300 of the first embodiment in that a staff management storing unit 304 is provided. The details of the staff management storing units 205 and 304 and the second processing unit 206 will be described later.

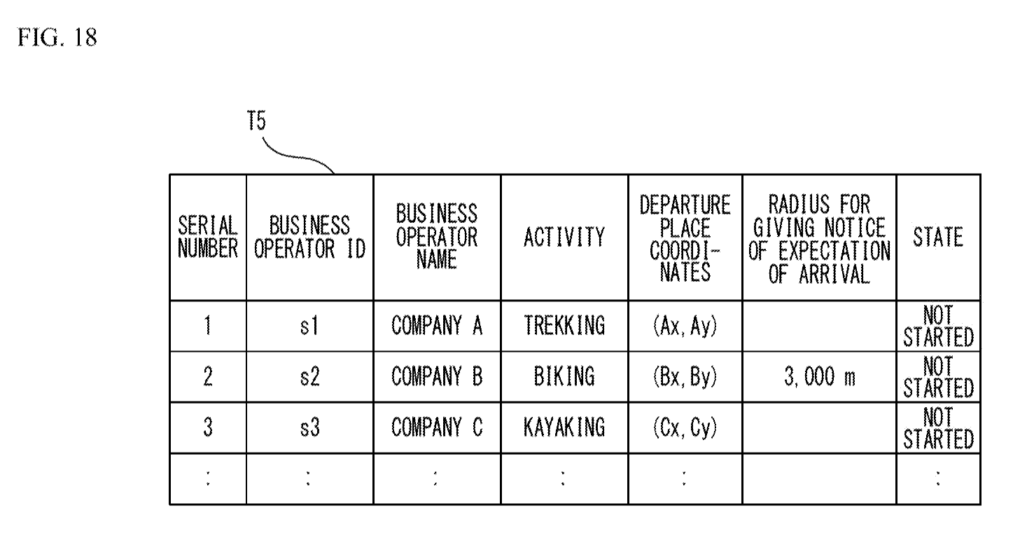

With reference to FIG. 18, the schedule storing unit 101 included in the user terminal 100 of the second embodiment will be described.

FIG. 18 illustrates a schedule table T5 in accordance with the second embodiment. The schedule information of the second embodiment is managed with the schedule table T5 as illustrated in FIG. 18. The schedule table T5 includes composition elements such as a serial number, a business operator ID, a business operator name, an activity, departure place coordinates, a radius for giving notice of expectation of arrival, and a state. In particular, the second embodiment differs from the first embodiment in that the radius for giving notice of expectation of arrival is predetermined by the business operator. In the second embodiment, the time for advance notice, the radius for starting measurement of speed, and the radius for terminating measurement of speed described in the first embodiment are excluded.

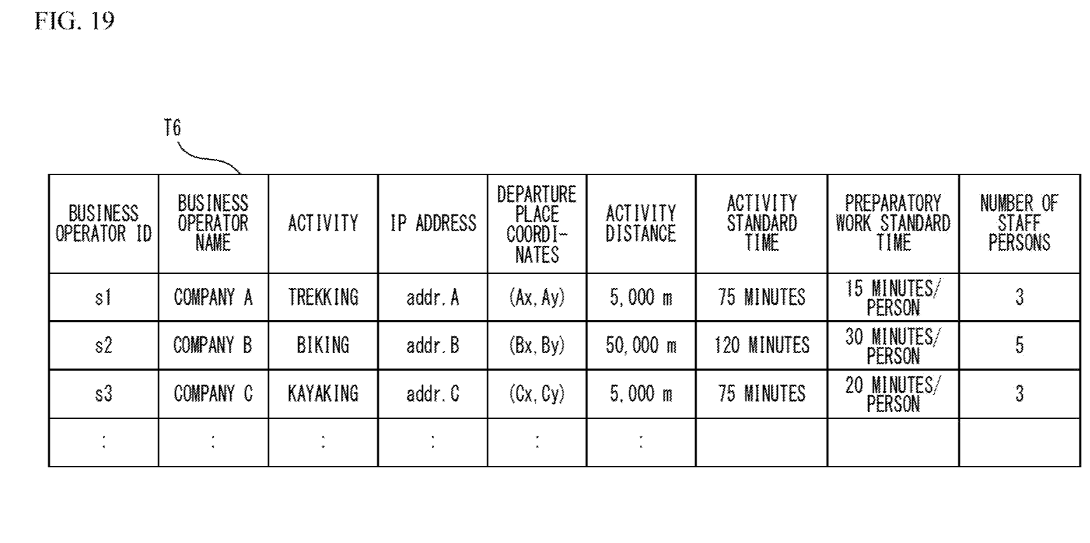

With reference to FIG. 19, the geofence storing unit 201 included in the management server 200 of the second embodiment will be described.

FIG. 19 illustrates a geofence table T6 of the second embodiment. The geofence information of the second embodiment is managed with the geofence table T6 as illustrated in FIG. 19. The geofence table T6 includes composition elements such as a business operator ID, a business operator name, an activity, an IP address, departure place coordinates, an activity distance, an activity standard time, a preparatory work standard time, and the number of staff persons. In particular, the second embodiment differs from the first embodiment in that the geofence table T6 includes the activity distance, the activity standard time, the preparatory work standard time, and the number of staff persons.

The activity distance indicates the movement distance of the activity to be conducted by the user 10. The activity standard time indicates the standard time required to conduct the activity. The preparatory work standard time indicates the standard time of the preparatory work for one person. The number of staff persons indicates the standard number of staff persons required for the preparatory work for the activity. The activity distance, the activity standard time, the preparatory work standard time, and the number of staff persons are determined by the business operator in advance.

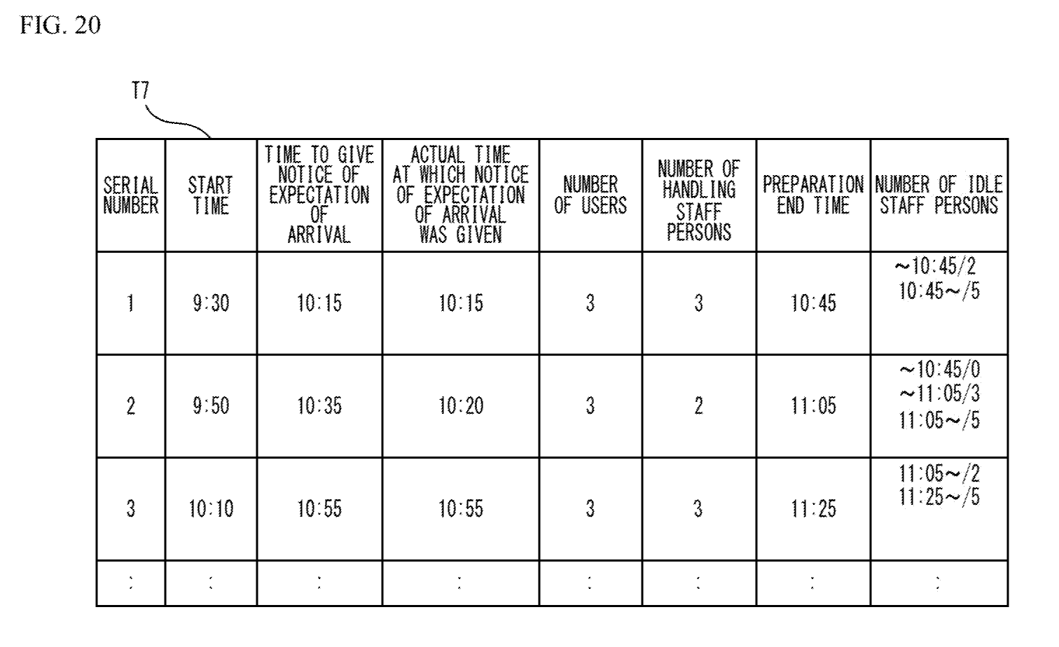

With reference to FIG. 20, the staff management storing unit 205 included in the management server 200 of the second embodiment will be described.

FIG. 20 illustrates a staff management table T7 of the second embodiment. The staff management information used in the second embodiment is managed with the staff management table T7 as illustrated in FIG. 20. The staff management table T7 includes composition elements such as a serial number, time to give notice of expectation of arrival, actual time at which notice of expectation of arrival was given, the number of users, the number of handling staff persons, a preparation end time, and the number of idle staff persons.

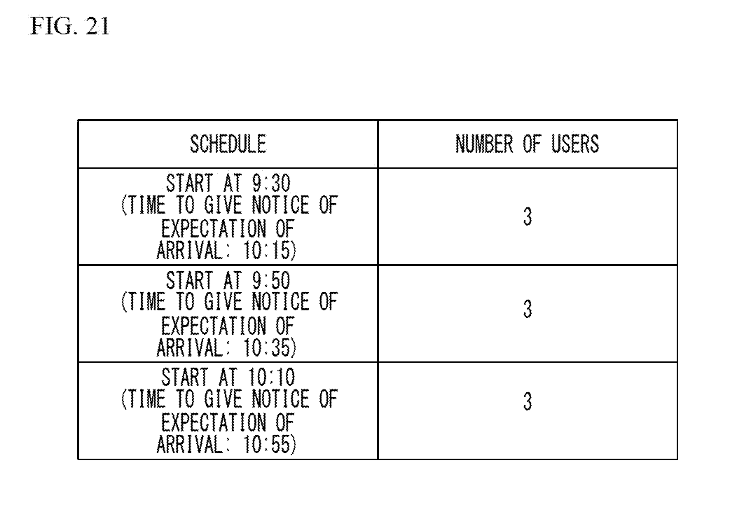

The serial number is identification information for identifying the staff management information. In the second embodiment, as illustrated in FIG. 21, groups each including three users conduct activities every 20 minutes from 9:30. Thus, the time at which the group starts the activity and the number of persons included in the group are registered in the start time and the number of users in the staff management information, respectively. The time several tens of minutes (e.g., 30 minutes) before the time at which the activity is ended from the activity standard time in the geofence table T6 is registered in the time to give notice of expectation of arrival. That is, when the activity standard time is 75 minutes, the next business operator is given notice of expectation of arrival when 45 minutes has elapsed from the start of the activity. On the other hand, the time at which one or all of the users of the group actually entered the third geofence GF3 is registered in the actual time at which notice of expectation of arrival was given.

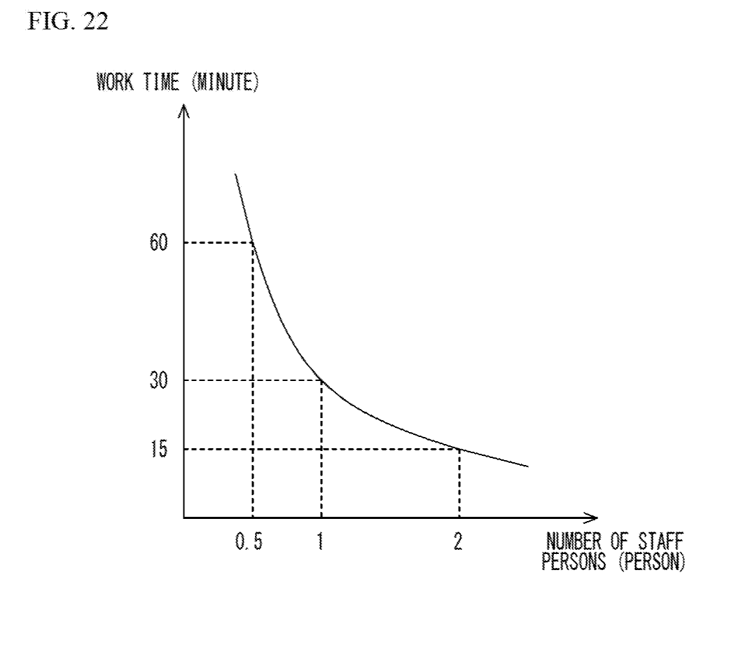

The number of handling staff persons indicates the number of staff persons required for preparation for the activity. For example, when the staff management table T7 is related to the business operator “company B”, three staff persons are required for the preparatory work of the bike 20. However, when the total number of staff persons of the business operator “company B” is five, if notice of expectation of arrival of the next group is given in the state where the preparatory work for the previous group is not finished, two staff persons except three staff persons who are working on the preparatory work need to conduct the preparatory work for the next group. As illustrated in FIG. 22, the time calculated based the function representing the relationship between the number of staff persons and the work time is registered in the preparation end time. For example, when it takes 30 minutes for one staff person to conduct the preparatory work for one user 10, the preparatory work for one user 10 is finished in 15 minutes if two staff persons conduct the preparatory work. In contrary, when one staff person conducts the preparatory work for two users 10, the preparatory work is finished in 60 minutes by assuming that the number of staff persons for one user 10 is 0.5. Thus, in the case of the staff management information of which the serial number is 2, two staff persons conduct the preparatory work for three users 10. Thus, the preparatory work is completed in 45 minutes, and the time 45 minutes after the actual time at which notice of expectation of arrival was given is registered in the preparation end time. The number of idle staff persons is the number of staff persons who are not involved in the preparatory work. The number of staff persons who are not involved in the preparatory work is registered in the number of idle staff persons in association with the preparation end time.

The above-described staff management information is also stored in the staff management storing unit 304 of the business operator terminal 300. For example, the second processing unit 206 generates the staff management information every time the registration of the activity to be conducted by the user 10 is detected from the user terminal 100, stores the generated staff management information in the staff management storing unit 205, and transmits the generated staff management information to the business operator terminal 300 through the communication unit 203. Accordingly, the updating unit 303 of the business operator terminal 300 stores the staff management information in the staff management storing unit 304. Both the user management storing unit 202 of the management server 200 and the user management storing unit 301 of the business operator terminal 300 store the user management information described in the first embodiment.

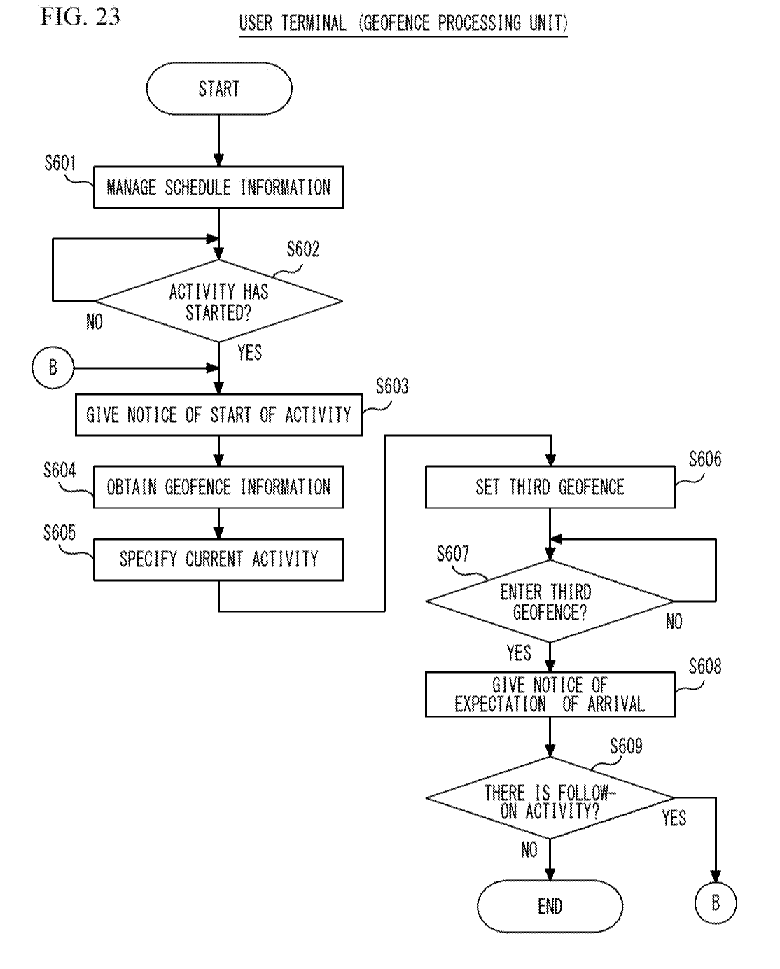

With reference to FIG. 23, a process executed by the geofence processing unit 104 of the second embodiment will be described. The process executed by the controller 103 of the second embodiment is the same as that of the first embodiment, and the description thereof is thus omitted.

The geofence processing unit 104 manages the schedule information (step S601). As described in the first embodiment, when the geofence processing unit 104 detects the registration of the tour described above, the geofence processing unit 104 manages the schedule information related to the registered tour. On completion of the process at step S601, the geofence processing unit 104 waits until an activity starts (step S602: NO). When an activity has started (step S602: YES), the geofence processing unit 104 gives notice of the start of the activity to the management server 200 (step S603), and obtains the geofence information (see FIG. 19) (step S604).

On completion of the process at step S604, the geofence processing unit 104 specifies the current activity (step S605). In more detail, the geofence processing unit 104 specifies the current activity based on the schedule information stored in the schedule storing unit 101. For example, the geofence processing unit 104 checks the states in the schedule information, and specifies the activity corresponding the state in which the flag “started” is registered. In the present embodiment, the geofence processing unit 104 specifies the activity “trekking”.

On completion of the process at step S605, the geofence processing unit 104 sets the third geofence (step S606). In more detail, the geofence processing unit 104 calculates the radius of the third geofence by using the activity distance and the activity standard time of the geofence information corresponding to the current activity specified in the process at step S605 and the time required for the preparatory work described above. For example, in the case of trekking of which the activity distance is 5,000 m and the activity standard time is 75 minutes, the geofence processing unit 104 calculates the standard moving speed of the first group by calculating 5,000 m/75 minutes, and calculates the radius of 2,000 m by multiplying the moving speed with the time required for the preparatory work when the time required for the preparatory work is 30 minutes. In the same manner, when the time required for the preparatory work is 45 minutes, the geofence processing unit 104 calculates the radius of 3,000 m. The geofence processing unit 104 registers the calculated radius in the radius for giving notice of expectation of arrival in the schedule information of the next activity (see FIG. 18). After registering the calculated radius, the geofence processing unit 104 sets the third geofence in the user terminal 100 by using the radius and the departure place coordinates corresponding to the radius.

On completion of the process at step S606, the geofence processing unit 104 waits until the user 10 enters the third geofence (step S607: NO). When the user 10 has entered the third geofence (step S607: YES), the geofence processing unit 104 gives notice of expectation of arrival (step S608).

On completion of the process at step S608, the geofence processing unit 104 determines whether there is a follow-on activity (step S609). When determining that there is a follow-on activity (step S609: YES), the geofence processing unit 104 returns to the process at step S603. On the other hand, when determining that there is no follow-on activity (step S609: NO), the geofence processing unit 104 ends the process.

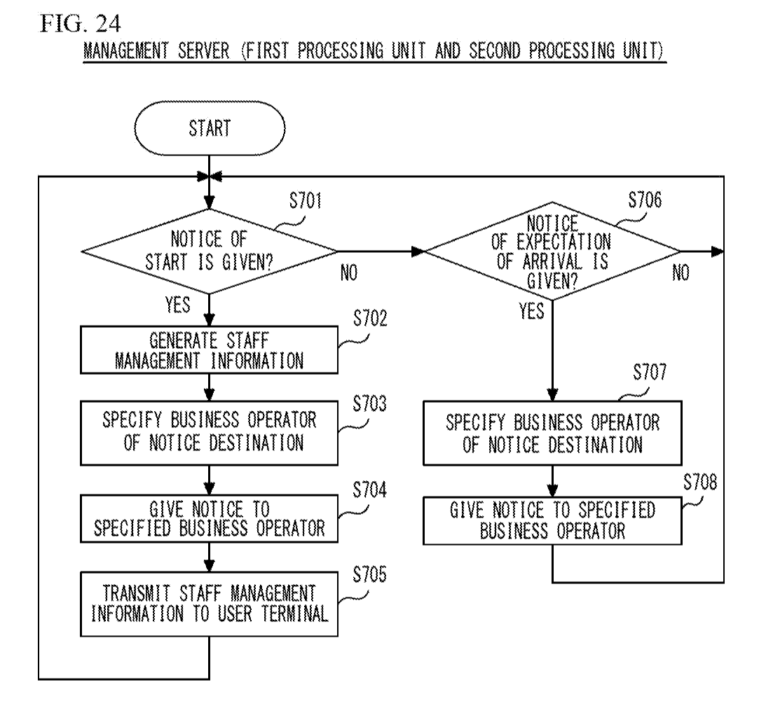

With reference to FIG. 24, a process executed by the first processing unit 204 and the second processing unit 206 will be described. As illustrated in FIG. 24, the first processing unit 204 waits until a notice of the start of an activity is given (step S701: NO). When the first processing unit 204 is given notice of the start (step S701: YES), the second processing unit 206 generates the staff management information (step S702).

On completion of the process at step S702, the first processing unit 204 specifies the business operator of the notice destination (step S703). For example, when the notice is a notice of the start of an activity, the first processing unit 204 specifies, based on the business operator ID given together with the notice, the business operator having the given business operator ID as the business operator of the notice destination.

On completion of the process at step S703, the first processing unit 204 gives notice of the start of an activity to the specified business operator (step S704). On completion of the process at step S704, the second processing unit 206 transmits the staff management information to the user terminal 100 (step S705). This allows the user terminal 100 to check the time required for the preparatory work and calculate the radius of the third geofence. On completion of the process at step S705, the first processing unit 204 executes the process at step S701.

On the other hand, when the first processing unit 204 is not given a notice of the start (step S701: NO) and is given a notice of expectation of arrival (step S706: YES), the first processing unit 204 specifies the business operator of the notice destination (step S707). For example, when the notice is a notice of expectation of arrival, the first processing unit 204 specifies, based on the business operator ID given together with the notice of expectation of arrival, the business operator having the given business operator ID and providing the next activity as the business operator of the notice destination.

On completion of the process at step S707, the first processing unit 204 gives notice of expectation of arrival of the activity to the specified business operator (step S708). In more detail, on completion of the process at step S707, the first processing unit 204 maintains the current activity in the user management information, and give notice of expectation of arrival of the user 10 to the business operator. For example, the first processing unit 204 specifies the business operator ID sequence in the user management information based on the user ID, and gives notice of expectation of arrival of the user 10 to the business operator together with the user ID and the business operator ID while maintaining the current activity based on the business operator ID and the specified business operator ID sequence.

When a notice of expectation of arrival is not given (step S706: NO), the first processing unit 204 executes the process at step S701. The process of the business operator terminal 300 to which the notice is given by the processes at steps S704 and S708 is the same as that in the first embodiment described with reference to FIG. 16, and the description thereof is thus omitted.

As described above, in the second embodiment, the availability of the staff persons conducting the preparatory work for the activity is managed, and the geofence processing unit 104 calculates the radius of the third geofence based on the time required for the preparatory work according to the availability. This configuration allows to set the third geofence according to the state of traveling of the user 10 (in particular, the actual time at which notice of expectation of arrival was given) in the user terminal 100, and preparation for accepting the user by the business operator is assisted.

### Third Embodiment

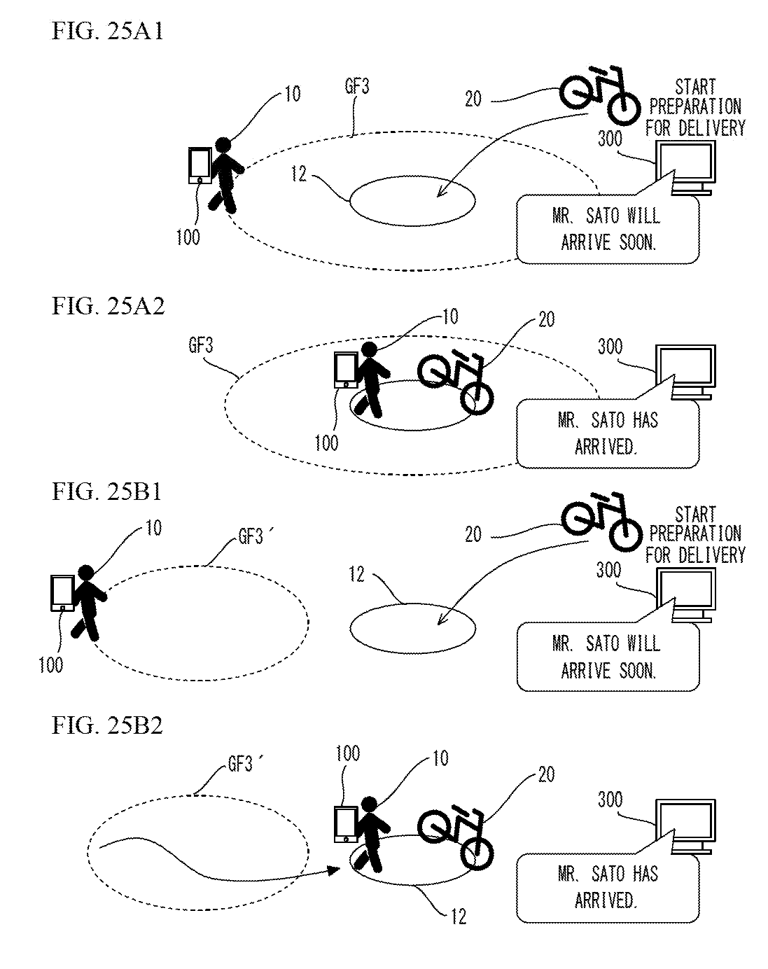

With reference to FIG. 25A1 through FIG. 25B2, a third embodiment will be described. FIG. 25A1 and FIG. 25A2 illustrate an example of the third geofence GF3. FIG. 25B1 and FIG. 25B2 illustrate another example of a third geofence GF3′. The third geofence GF3 in FIG. 25A1 and FIG. 25A2 corresponds to that in FIG. 14C and FIG. 14D in the first embodiment.

As illustrated in FIG. 25A1 and FIG. 25A2, the center of the third geofence GF3 may be the same as the center of the via-location 12, but the center of the third geofence GF3′ may differ from the center of the via-location 12 as illustrated in FIG. 25B1 and FIG. 25B2. For example, the center of the third geofence GF3′ may be on the course of the activity. The distance between the center of the via-location 12 and the center of the third geofence GF3′ may be changed according to the type of the activity. For example, in the case of trekking, the center of the third geofence GF3′ may be set at the position 2,000 m to the center of the via-location 12, and in the case of biking, the center of the third geofence GF3′ may be set to the position 5,000 m to the center of the via-location 12. This makes the form of assisting preparation for accepting the user flexible.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention. For example, the above-described speed information may be calculated based on the positional information of the user 10 by the GPS sensor 100F and the moving time of the user 10 without using the first geofence GF1 and the second geofence GF2. The above-described embodiments use the IP address, but instead of the IP address, other addresses enabling the communication between devices such as a mail address may be used. Furthermore, in the above-described embodiment, the via-location 12 is located away from the business office X of the business operator “company B”, but the business office X may be located in the via-location 12. Furthermore, in the above-described embodiment, all the first geofence, the second geofence, and the third geofence have a circular shape, but one or all of them may have a polygonal shape instead of a circular shape.

What is claimed is:

1. A non-transitory computer readable storage medium storing a control program causing a computer to execute a process, the process comprising:
storing schedule information including an execution order of activities to be conducted by a user;
obtaining geofence information including positional information and time information, the positional information indicating a departure place of each activity of the activities, the time information indicating time to transmit an advance notice regarding expectation of arrival at a first departure place of a first activity next to a second activity to a first device of a business operator providing the first activity, the first and second activities being from among the activities;
specifying a next activity to be conducted by the user based on the schedule information;
generating, based on time information in the geofence information corresponding to the next activity and speed information indicating a speed at which the user moves, distance information corresponding to the time information; and
transmitting, to a device of a next business operator providing the next activity, the advance notice regarding expectation of arrival of the user at a next departure place of the next activity based on entering of the user into a geofence defined by the positional information of the geofence information corresponding to the next activity and the distance information.

2. The non-transitory computer readable storage medium according to claim 1, wherein
the geofence information further includes radius information related to two geofences,
the two geofences are defined by identical positional information and different radius, and
the process further comprises calculating the speed information based on other time information indicating moving time of the user who moves in a zone defined based on the positional information and the radius information.

3. The non-transitory computer readable storage medium according to claim 1, wherein
the activities include an activity requiring a movement of the user from a departure place to a destination and another activity not requiring a movement of the user from another departure place to another destination.

4. A control method implemented by a computer, the control method comprising:
storing schedule information including an execution order of activities to be conducted by a user;
obtaining geofence information including positional information and time information, the positional information indicating a departure place of each activity of the activities, the time information indicating time to transmit an advance notice regarding expectation of arrival at a first departure place of a first activity next to a second activity to a first device of a business operator providing the first activity, the first and second activities being from among the activities;
specifying a next activity to be conducted by the user based on the schedule information;
generating, based on time information in the geofence information corresponding to the next activity and speed information indicating a speed at which the user moves, distance information corresponding to the time information; and
transmitting, to a device of a next business operator providing the next activity, the advance notice regarding expectation of arrival of the user at a next departure place of the next activity based on entering of the user into a geofence defined by the positional information of the geofence information corresponding to the next activity and the distance information.

5. An information processing device comprising:
a memory storing schedule information including an execution order of activities to be conducted by a user; and
a processor coupled to the memory and configured to:
obtain geofence information including positional information and time information, the positional information indicating a departure place of each activity of the activities, the time information indicating time to transmit an advance notice regarding expectation of arrival at a first departure place of a first activity next to a second activity to a first device of a business operator providing the first activity, the first and second activities being from among the activities,
specify a next activity to be conducted by the user based on the schedule information,
generate, based on time information in the geofence information corresponding to the next activity and speed information indicating a speed at which the user moves, distance information corresponding to the time information, and
transmit, to a device of a next business operator providing the next activity, the advance notice regarding expectation of arrival of the user at a next departure place of the next activity based on entering of the user into a geofence defined by the positional information of the geofence information corresponding to the next activity and the distance information.

6. The information processing device according to claim 5, wherein
the geofence information further includes radius information related to two geofences,
the two geofences are defined by identical positional information and different radius, and
the processor is further configured to calculate the speed information based on other time information indicating moving time of the user who moves in a zone defined based on the positional information and the radius information.

7. The information processing device according to claim 5, wherein
the activities include an activity requiring a movement of the user from a departure place to a destination and another activity not requiring a movement of the user from another departure place to another destination.
